(19) United States
(12) Patent Application Publication
(10) Pub. No.: US 2020/0377297 A1
(43) Pub. Date: Dec. 3, 2020

(54) BAG WITH VENTILATION HOLE AND REINFORCED AREA TO ADAPT TO A RECEPTACLE

(71) Applicant: LORENA DORDAN, Westminster, CA (US)

(72) Inventor: LORENA DORDAN, Westminster, CA (US)

(21) Appl. No.: 16/428,654

(22) Filed: May 31, 2019

(51) Int. Cl. B65F 1/00; B65D 33/28

(52) U.S. Cl. CPC B65F 1/0006; B65F 2210/181; B65D 33/28

(57) ABSTRACT

The present invention called bag with ventilation hole and reinforced area to adapt to a receptacle, comprises a folding upper edge located in the upper area of the neck of the bag and a reinforced area located below the folding upper edge that includes at least one hole in the bag for ventilation. All of this allows the bag to have the capacity to expand its entire storage area inside a receptacle and as a mutual benefit the extraction of accumulated air between the bag and the receptacle; providing an improvement in storage and superior use of space.

### TECHNICAL FIELD

The present invention relates to a type of bag for containing and storing materials or elements that present special storage problems; adapted for several different purposes, such as the storage and disposal of waste or other materials or elements.

### STATE OF THE ART

At present there are many types of bags for different uses and modalities. In the field of bags for the disposal of materials, the garbage bag industry has focused its efforts on the creation of novel designs of garbage bags. These creations include greater polymeric elastic resistance and diamond poly designs in the walls of a bag. Odor control poly materials to keep the smell inside the closed bag. bags with zippers, bags with clip-type closures, storage bags with screw caps, and drawstring bags to improve the closure and use the cord as handle at the time of manually transporting the bag to the main trash can; as well as. patent document ES2270041 disclosing a bag with closed cord and traction adjustment with adhesive tape.

However, the bags with closed laces as the patent document ES2270041 lacks ventilation holes that allows the removal of the trapped and accumulated air in the bag, for an adequate use of the overall space of the bag itself. It is also well known the garbage bag we all use in our homes and office, which is typically a polymeric bag designed to be used as a depository for waste generated by everyday activity. To keep it open, the garbage bag is placed in a rigid receptacle and usually uncovered by adjusting or bending the ends to its sides. In homes, the bag is placed in the trash receptacle that is placed in different places such as; the kitchen, bathroom, office and work areas to accumulate waste that is generated continuously. Once these bags accumulate waste they are closed and then discarded in larger receptacles collected by the garbage truck.

On the other hand, the bags receive some attention in regard to the problem of air accumulation and the lack of proper use of the space inside the bag. Some air ventilation options have been invented only in the body of the bag; as well as patent document ES1093434U disclosing a vacuum storage bag.

Finally, none of the aforementioned antecedents allows the extraction of entrapment of accumulated air between the outer liner of the bag and the inner walls of the receptacle, which limits the storage and the use of space of the bag. In addition, there is evidence of the lack of a hermetic seal that perfectly closes the bag so that it does not let air, liquid or any other contents or waste pass through or escape.

### DESCRIPTION OF THE INVENTION

As a solution to the aforementioned problems the present invention was developed which provides a simple but very effective solution that helps the bag to expand its entire storage area inside a receptacle and as a mutual benefit the extraction of accumulated air between the bag and the receptacle; providing better storage and better use of space. The bag with ventilation hole and reinforced area to adapt to receptacles includes the following elements:

Bag (1).—Bag (1) is understood as a type of container that can be of any material or combination of materials or elements, type, size, shape or color and generally used to carry objects and accumulated waste comfortably. The bag (1) has the ability to adapt to the shape of any receptacle (8).

At least one folding upper edge (2).—Located in the upper area of the neck of the bag (1), so that when the mouth of the bag (1) is folded to the edge of the mouth of a receptacle (8), the upper folding edge of the bag takes the proper shape and fits into any receptacle (8).

At least one adjustment cord (3).—Located on the upper folding edge (2) and used to close the bag (1) once the items to be stored or discarded are contained. Alternatively, the closing and adjustment cord (3) is used as a handle to transport the bag (1).

At least one reinforced area (4).—Located in the upper part of the bag (1) under the upper folding edge (2) positioned semi or completely in the body of the bag (1). The reinforced area (4) prevents any tearing or breaking around the ventilation hole (5), which offers greater strength.

The reinforced area (4) comprises at least one vent hole (5) which provides the advantage of complete expansion of the internal and external area of the accumulative capacity of deposited waste or any other elements and materials within the bag (1), likewise offers the advantage of full expansion of the walls of the bag (1) inside the receptacle (8).

At least one ventilation hole (5) provides the advantage of releasing the trapped air between the interior of the receptacle (8) and the outer walls of the bag (1) offering more space to store more items or waste. The vent hole is indispensable to completely and efficiently use the internal area of the bag (1) and the space offered by the receptacle (8).

At least one adhesive inner area (6).—Located below the reinforced area (4) and inside the bag (1), said inner adhesive area (6) serves as a seal for the bag (1) when it is required to isolate, retain, store, discard or move the contents. An alternative use is for catching insects who want to access the inside of the bag (1).

The adhesive inner area (6) is protected by at least one mobile protective cover (7), preferably made of PVC or any other element or material, which is lifted when it is required to make use of the adhesive inner area (6).

All of this generates an improvement in the state of the art since the bag with at least one ventilation hole and reinforced area can adapt to any receptacle and grants:
Greater security to the ventilation holes (5) that commonly tear and break.
It allows for a better and more efficient use of space, thanks to the ventilation holes (5) that are responsible for extracting the trapped or accumulated air between the bag (1) and the receptacle (8).
It generates a complete and safe closing, by the disposition and function of the adhesive interior area (6).

### BRIEF DESCRIPTION OF THE FIGURES

FIG. 1.—Shows a front view of the open bag (1).

FIG. 2.—Shows a front view of the bag (1) opened and installed in a receptacle (8), the foldable upper edge (2), the adjustment cord area (3), the reinforced area (4), the ventilation hole (5) and the adhesive inner area (6).

FIG. 3.—Shows an inside front view of the bag (1), a moment before removing the mobile protective cover (7) and uncovering the adhesive interior area (6).

FIG. 3.1.—Shows an internal front view of the bag (1), where the adhesive interior area (6) is evident.

FIG. 4.—Shows a cross-sectional view of the open bag (1) fitted by the foldable upper edge (2) to some receptacle (8); where, the air accumulated between the receptacle (8) and the bag (1) comes out through the ventilation hole (5) providing the complete use of space inside the total bag area (1).

FIG. 5.—Shows a top view of the inside of the bag (1), also an isometric front angle, where the user is ready to lift the bag (1) by means of the adjustment cord (3), showing the reinforced area (4), the ventilation hole (5), and the adhesive interior area (6).

FIGS. 5.1, 5.2, and 5.3.—Show a series of views of how the adhesive inner area (6) joins with each other, for sealing the bag (1) when it is required to completely isolate the contents.

FIG. 5.4.—Shows a transverse front view of how the reinforced area (4) shrinks and closes the ventilation hole (5), and how the adhesive interior area (6) joins with each other, for sealing the bag (1).

FIG. 6.—Shows a front view of the closed bag (1), where the closure and adjustment cord (3) is used as a handle for transporting the bag (1).

FIG. 6.1.—Shows a cross-sectional view of the bag (1), where the reinforced area (4) and the ventilation hole (5) shrink and close, and the adhesive inner area (6) is joined together, providing a more secure closure of the bag (1).

### LIST OF REFERENCE NUMBERS OF THE DRAWINGS

1. Bag
2. Foldable upper edge
3. Adjustment cord
4. Reinforced area
5. Ventilation hole
6. Adhesive inner area
7. Mobile protective cover
8. Receptacle

### PREFERRED EMBODIMENT OF THE INVENTION

The preferred description of this invention does not limit its commercial uses.

The figures are made for a better understanding of the description and variations such as shape, size, design, material or others can be modified according to the industry to suit the particular use.

The use of conventional bags or garbage bags for receptacles has a drawback that causes the entrapment of air between the liner of the bag and the inner walls of the receptacle. Due to this, air is often trapped in this manner when the liner is first placed inside the receptacle. This trapped air prevents the liner of the bag from expanding to its most capacity area of designed configuration within the interior of the receptacle and, therefore, limits the amount of garbage that can be retained.

As a solution, a bag with at least one ventilation hole and reinforced area was developed to be better fitted to a receptacle (8) by generating a natural vacuum force effect, where said bag (1) has a reinforced area (4), a vent hole (5) whose structure allows a better use of the space inside the bag (1) and between the interior of the receptacle (8) and the liner of the bag (1). Where also the adhesive interior area (6) allows better closure; favoring the best use of the bag (1), its space, practicality and maneuverability when using, loading and discarding.

It should also be noted that the bag (1) and its reinforced area (4) including at least one ventilation hole (5), can be made of any suitable material and for many purposes.

Plastic bags are mainly composed of polymers made from High, Low, and liner low densities of polyethylene materials; these are well-known as superior for the body of a common bag, and it is important to note that this document does not limit the use of any other element or material for the creation of the bag.

### EXAMPLES OF THE WAY OF USE

The unique characteristics and advantages of the bag (1) described above will be apparent with reference to the following detailed description taken together with the figures, wherein;

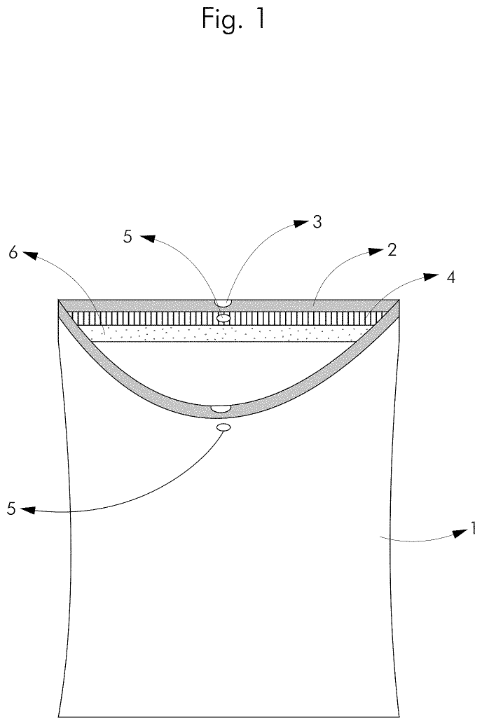

FIG. 1.—Shows a side view of the embodiment of the bag (1), wherein the following elements can be evidenced: The foldable upper edge (2) with the adjustment cord (3), the reinforced area (4) with at least one ventilation hole (5) and the adhesive interior area (6).

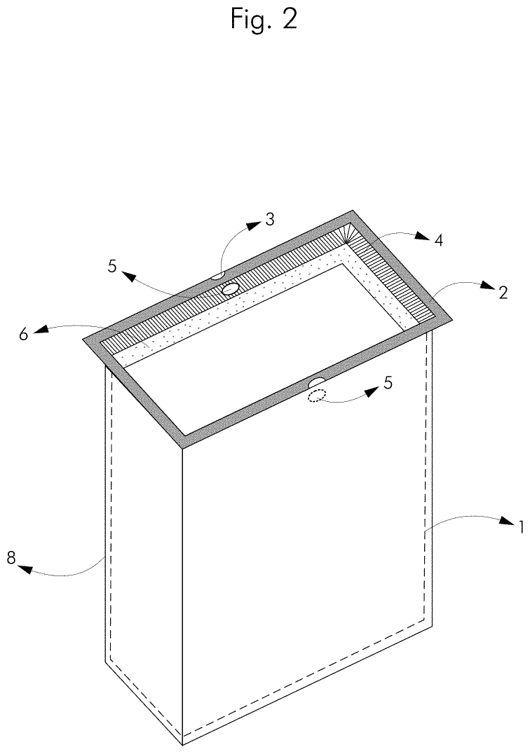

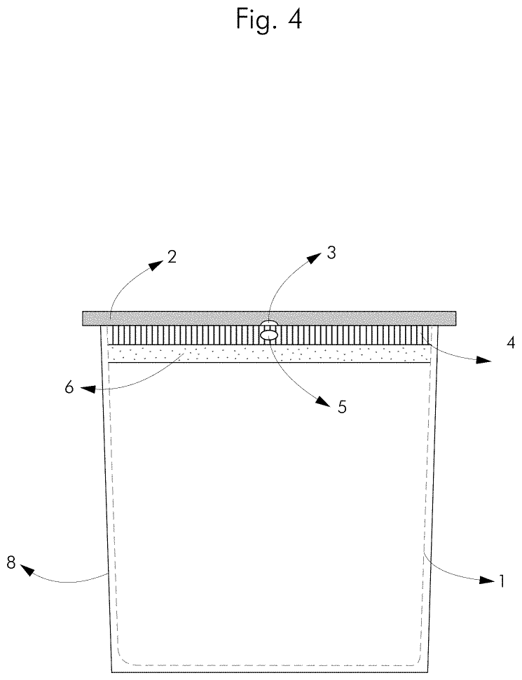

FIGS. 2 and 4.—Shows how the bag (1) is better fitted to the interior of a receptacle (8). Once the foldable upper edge (2) is folded against the upper mouth of the receptacle (8) in which this arrangement provides a better support of the overall body of the bag (1). Also, the reinforced area (4) and the at least one ventilation hole (5) facilitates the evacuation and ventilation of trapped air between the liner of the bag (1) and its receptacle (8); thus allowing more usable space and better arrangement of the space of the bag (1) to better store the various materials, devices, waste, or any other elements.

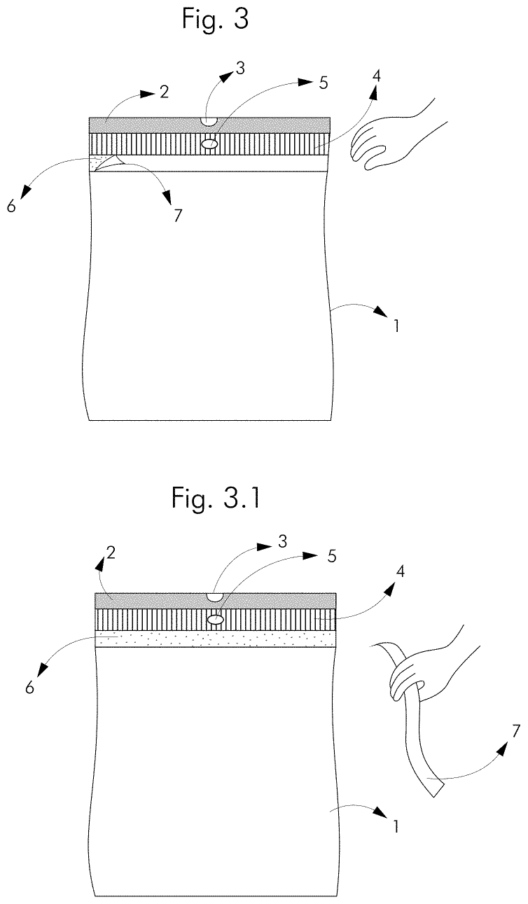

FIGS. 3 and 3.1.—Shows an internal front view of the bag (1), the removal process of the mobile protective cover (7) and the adhesive inner area (6).

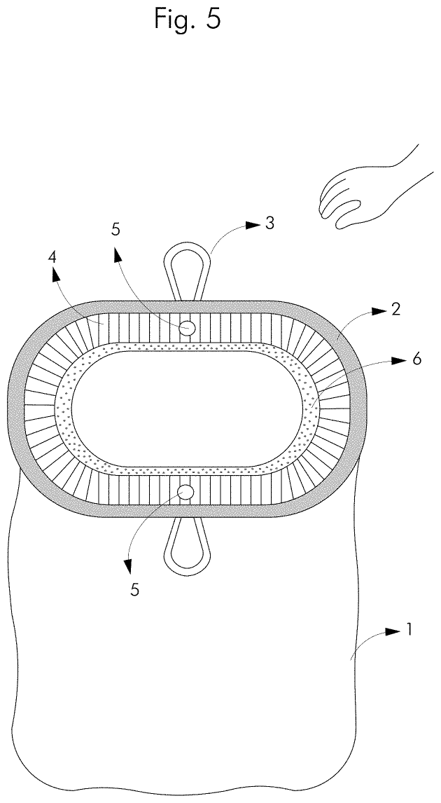

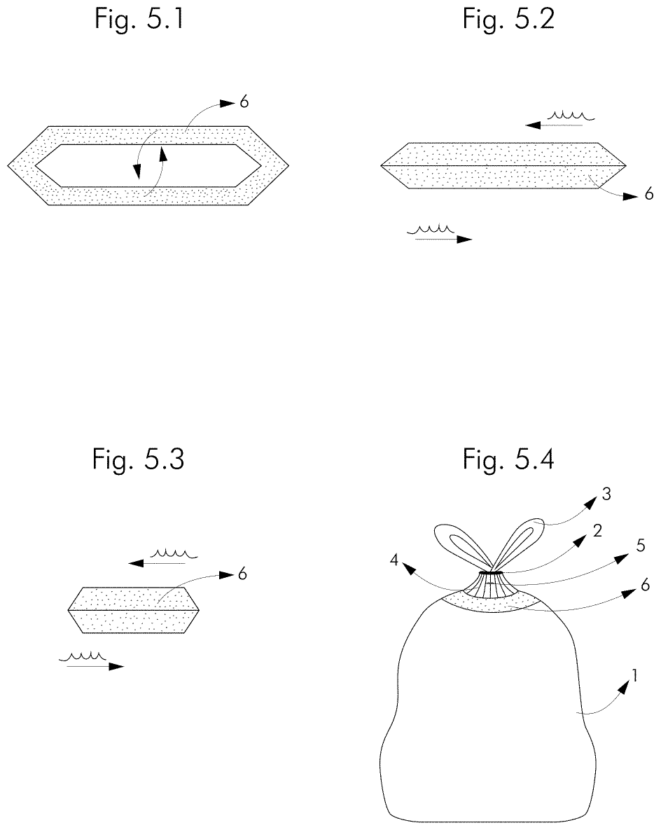

FIG. 5.—Shows the inside adhesive area (6), which can have a sweet aroma for the home which in turn can attract insects and these are trapped inside the bag (1).

FIGS. 5.1, 5.2 and 5.3.—Shows the adhesive area (6) before closing, closing and shrinking respectively.

FIG. 5.4.—Show a transverse front view of how the reinforced area (4) shrinks and closes the ventilation hole (5), and how the adhesive interior area (6) joins together, for the hermetic sealing of the bag (1).

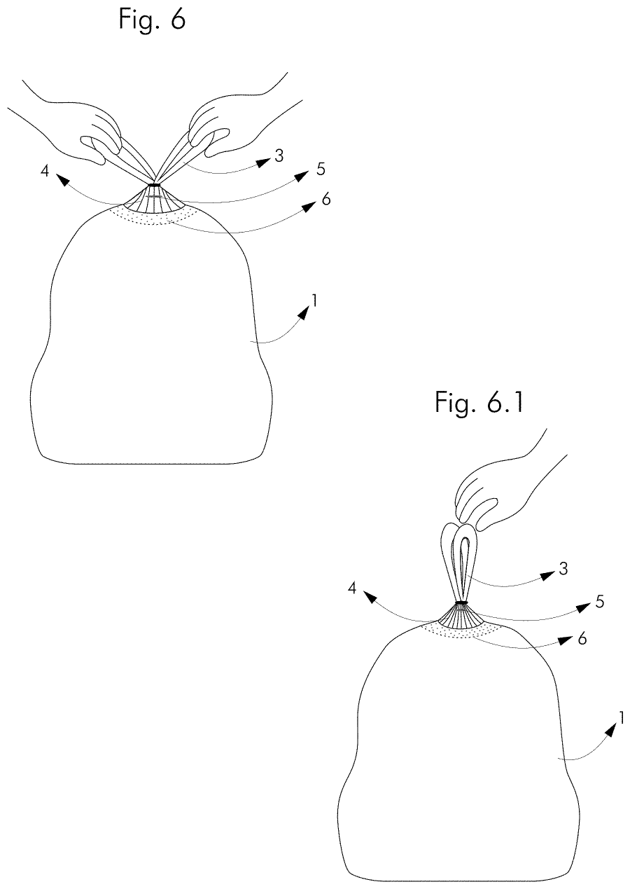

FIGS. 6 and 6.1.—Shows a front view of the bag (1) closed and filled with waste or any other materials or elements, where the ventilation holes (5) facilitated the evacuation and ventilation of accumulated air inside the bag (1). In addition the adhesive inner area (6) is joined to each other, providing a more secure and airtight seal.

### INDUSTRIAL APPLICATION

The industrial application of the present invention may vary for different uses and industries, among the most common applications are the following:
Kitchen bags, office, bathroom for daily waste and garbage,
Large bags for gyms, Public parks, stadiums or large community centers,
Bags for various materials,
Bags of protection and storage,
Bags to load objects,
Manufacturing bags for industrial uses and businesses.

1. A bag with ventilation hole and reinforced area for generating a vacuum force is characterized in that it comprises at least one foldable upper edge (2) located in the upper area of the neck of the bag (1) and at least one reinforced area (4) located below of the foldable upper edge (2), wherein said reinforced area (4) includes at least one ventilation hole (5).

2. The bag with ventilation hole and reinforced area according to claim 1, is characterized in that it comprises at least one interior adhesive area (6) with at least one mobile protective cover (7).

3. The bag with ventilation hole and reinforced area according to claim 1, is characterized in that the reinforced area (4) is located below the foldable upper edge (2).

4. The bag with ventilation hole and reinforced area according to claim 2 is characterized in that the adhesive inner area (6) is located below the reinforced area (4) and inside the bag (1).

5. The bag with ventilation hole and reinforced area according to claims 2 and 4, is characterized in that the adhesive inner area (6) seals the bag (1) when it is required to isolate, retain, store, discard, or move the contents.

6. The bag with ventilation hole and reinforced area according to claim 2, characterized in that the mobile protective cover (7), is removed when it is required to use the adhesive interior area (6).

7. The bag with ventilation hole and reinforced area according to claim 1, is characterized in that the bag (1) can be of any type, size, color, shape, design, materials or elements.

8. The bag with ventilation hole and reinforced area according to claim 1, is characterized in that the foldable upper edge (2) is elastic and flexible for fitting in the upper mouth of a receptacle (8).
